(19) United States
(12) Patent Application Publication
(10) Pub. No.: US 2011/0090503 A1
(43) Pub. Date: Apr. 21, 2011

(54) APPARATUS FOR DETECTING ARCS

(76) Inventors: Kang LEE, Siheung-si (KR); Sang Jeen HONG, Yongin (KR); Sang Youl LEE, Siheung-si (KR); Jong Hwan Ahn, Seoul (KR)

(21) Appl. No.: 12/772,598

(22) Filed: May 3, 2010

(30) Foreign Application Priority Data
Oct. 15, 2009 (KR) 10-2009-0098004

(51) Int. Cl. G01N 21/25; G08B 17/10

(52) U.S. Cl. 356/406; 340/632

(57) ABSTRACT

An apparatus for detecting arc that can monitor inside of process chamber sensitively and promptly can be provided, and abnormal condition of plasma in process chamber can be detected. And, by installing RGB sensor portion independently or installing the RGB sensor portion in master board, flexibility in configuration can be provided.

### CROSS REFERENCE

This application claims foreign priority under Paris Convention and 35 U.S.C. §119 to Korean Patent Application No. 10-2009-0098004, filed Oct. 15, 2009 with the Korean Intellectual Property Office.

### BACKGROUND OF THE INVENTION

1. Technical Field

The present invention relates to an apparatus for detecting arc, more specifically to an apparatus for detecting arc in which RGB sensor portion is installed independently or RGB sensor portion is integrally installed in master board, thereby structural flexibility of apparatus can be secured and condition change of plasma can be sensed in real time, and when abnormal condition in plasma or arc is occurred, direct check from outside and by that minute process control can be possible.

2. Description of the Related Art

Generally, manufacturing process for integrated circuit of semiconductor includes various unit process such as cleaning process, ion implantation process, photograph process, thin film deposition process, etching process, chemical or mechanical polishing process, etc.

Plasma treatment process in manufacturing process for integrated circuit of semiconductor is a essential process for manufacturing minute integrated circuit, and representative unit process using plasma treatment is drying etching process and dry deposition process.

In the plasma process, to form minute line width in integrated circuit of semiconductor, variation in process input parameter should be changed in very small range, and examples of the process input parameter is quantity of reaction gas, pressure of chamber, magnitude of applied electric power, etc.

Meanwhile, when the unit process is repetitively performed in manufacturing process of integrated circuit of semiconductor, process condition of plasma treatment may be changed to be different from the condition that is set by parameters because of failure in device or error by other unknown causes.

For dry deposition process, very small change in process input parameter can change width and etching characteristic of thin layer.

And, for dry etching process, very small change in process input parameter can effect on etch rate, selectivity, and uniformity.

In etching process using plasma, undesired change in process input parameter can affect on line width of minute pattern and side wall slope of pattern, thereby it can disturb formation of accurate and minute integrated circuit.

It is known to be important to determine abnormality in process using plasma by detecting minute change in process input parameter, and by this, it can be early prevented to convey defective wafer by process error to next process.

For that reason, it is necessary to develop a method for monitoring abnormality occurrence in process accurately by real time.

Here, several conditions necessary for an apparatus for monitoring plasma process are as follows.

1) Output data should be simple for direct figuring out of process condition.

2) Time for processing output data should be short.

3) It should be possible to analyze result of estimation quantitatively.

4) Installation of sensor should not affect on real progress of process.

5) Sensitivity of sensor should be high enough to detect very small error.

6) In side of process diagnosis, the apparatus should be configured so that operator easily understand and determine correctly result of diagnosis.

Until now, as an apparatus for plasma monitoring, Langmuir probe, SEERS (Self-excited electron spectroscopy), OES (Optical emission spectroscopy), etc. are produced and used in plasma process.

However, the Langmuir probe has a disadvantage that sensors are inserted in chamber, so metal tips are exposed to plasma, and the OES has a disadvantage that result of estimation is shown in a type difficult for direct interpretation or judgment, and the SEERS has a disadvantage that sensitivity of sensor is low, so it is difficult to figure out condition of plasma accurately and promptly.

And, said apparatus are installed integrally with process chamber or sensors of the apparatus are installed in a specific area outside the chamber, so the sensors cannot be installed freely in a area that operator wants it to be.

### SUMMARY OF THE INVENTION

An advantage of some aspects of the present invention is to provide an apparatus for detecting arc that can monitor inside process chamber sensitively and promptly, and detect abnormal condition of plasma in process chamber.

Another advantage of some aspects of the invention is to provide an apparatus that has flexibility in configuration by installing RGB sensor portion independently or installing the RGB sensor portion in master board.

Another advantage of some aspects of the invention is to provide an apparatus that defect rate in manufacturing process can be reduced and minute process control is possible.

Another advantage of some aspects of the invention is to provide an apparatus in which plasma monitoring device can be installed firmly by using adaptor of various shape and correct plasma monitoring is possible by using connector to prevent light leakage.

Another advantage of some aspects of the invention is to provide an apparatus that can be installed freely disregards of structure, shape, and spatial restriction of chamber.

An aspect of the apparatus for detecting arc according to present invention comprises: a RGB sensor portion including RGB module sensing respective red, green, and blue color of light emitted from plasma in plasma process chamber; a master board processing signals from the RGB sensor portion and controlling the process chamber or displaying process condition of the chamber; a analogue digital converter for converting RGB signal sensed by the RGB sensor portion to digital signal; a color analysis portion converting digital RGB signal to numerically quantitative RGB light data of plasma by analysis for respective RGB signal; a comparison portion comparing the RGB light data transmitted from the color analysis portion with RGB light data obtained from plasma in normal condition; and the RGB module includes, a RGB color sensor receiving light of red, green, and blue from plasma gas in process chamber through R channel sensor, G channel sensor, and B channel sensor; a amplifier amplifying signal sensed by the RGB color sensor; and the master board includes, a main processor outputting control signal for controlling operation of process chamber or display signal for displaying condition of process chamber by gathering the RGB light data transmitted from the color analysis portion and signal transmitted from the comparison portion; an alarm portion outputting alarm melody or alarm light according to signal transmitted from the main processor; a real time display portion for displaying data related with process parameter in the process chamber according to the signal transmitted from the main processor such that operator may confirm condition of the process chamber.

Here, the RGB module may include, the analogue digital converter; and a signal processing portion having the color analysis portion, the comparison portion, and communication port portion communicating with the master board, and the RGB sensor portion including the RGB module is installed oppositely to view port of process chamber.

And, the RGB sensor portion and the master board are connected with each other by communication line, so the RGB sensor portion and the master board are installed independently of each other.

Or, the RGB sensor portion is provided in the master board integrally, and the master board may include the analogue digital converter, the color analysis portion, and the comparison portion.

Here, the master board including the RGB sensor portion may be installed oppositely to view port of process chamber

Meanwhile, the RGB module includes, a analogue digital converter; a signal processing portion having the color analysis portion, the comparison portion, and communication port portion communicating with the master board, and the RGB sensor portion including the RGB module is connected with view port of process chamber through optical cable.

Here, the RGB sensor portion is connected with the master board through communication line, and the RGB sensor portion and the master board are installed independently of each other.

Or, the RGB sensor portion is provided in the master board integrally, and the master board includes the analogue digital converter, the color analysis portion, and the comparison portion, the RGB sensor portion included in the master board may be connected with view port of process chamber through optical cable.

Meanwhile, RGB signal sensed by the RGB sensor portion is converted to numerical value of respective R channel data, G channel data, and B channel data in the color analysis portion, and R, G, B channel data transmitted from the color analysis portion are compared respectively with R, G, B channel data of process permission range in the comparison portion, and when at least one data of the respective channel data is out of the process permission range, plasma in the process chamber is determined to be in abnormal condition.

Or, RGB signal sensed by the RGB sensor portion is converted to numerical value of respective R channel data, G channel data, and B channel data in the color analysis portion, and the RGB channel data is converted to hue data, saturation data, and brightness data by combination, and the hue data, saturation data, and brightness data transmitted from the color analysis portion are compared respectively with hue data, saturation data, and brightness data of process permission range in the comparison portion, and when at least one data of the hue data, saturation data, and brightness data is out of the process permission range, plasma in the process chamber is determined to be in abnormal condition.

Here, the apparatus further comprises adaptor and connector for connection between the RGB sensor portion and view port of process chamber.

And, the adaptor may have “+” shape.

Here, the adaptor may have gradually protruded shape toward central portion.

And, screw hole is formed in the adaptor, and screw protrusion that has cylindrical shape in which hollow part is formed in central portion is formed in central portion of the connector, the adaptor and the connector may be connected by bolt-nut connection type.

Or, insert hole is formed in the adaptor, and insert protrusion that has cylindrical shape in which hollow part is formed in central portion is formed in central portion of the connector, the adaptor and the connector may be connected by insert connection type.

Here, the connector is installed in lower part of the master board, the RGB module may be installed oppositely to the connector in the master board.

### BRIEF DESCRIPTION OF THE DRAWINGS

FIG. 1 is a schematic view of process system in which apparatus for detecting arc according to present invention is applied.

FIG. 2 is a schematic view of RGB sensor portion.

FIGS. 3a and 3b are schematic views of various embodiments of adaptor included in the RGB sensor portion.

FIGS. 4a and 4b are cross sectional views showing connection structure of adaptor, connector, and RGB module.

FIG. 5 is a block diagram of RGB sensor portion and master board.

FIG. 6 is a schematic view of process system in which apparatus for detecting arc according to another embodiment of present invention is applied.

FIG. 7 is a block diagram of RGB sensor portion and master board.

FIG. 8 is a schematic view of plasma process apparatus in which devices are connected by optical cable.

FIG. 9 is a schematic view of plasma process apparatus according to another embodiment.

FIG. 10 is a schematic side cross sectional view of master board that includes RGB sensor portion.

FIGS. 11a and 11b are graphs in which RGB light data space of process permission range is represented in three-axis coordinate.

FIGS. 12a to 12c are graphs in which value of RGB light data according to change of process input parameter is represented.

### DESCRIPTION OF SPECIFIC EMBODIMENTS

Hereinafter, embodiments of the present invention will be described in detail with reference to drawings.

Before the detailed description, it should be noted that the terms used in the present specification and the claims are not to be limited to their lexical meanings, but are to be interpreted to conform with the technical idea of the present invention under the principle that the inventor can properly define the terms for the best description of the invention made by the inventor.

Therefore, the embodiments and the constitution illustrated in the attached drawings are merely preferable embodiments according to the present invention, and thus they do not express all of the technical idea of the present invention, so that it should be understood that various equivalents and modifications can exist which can replace the embodiments described in the time of the application.

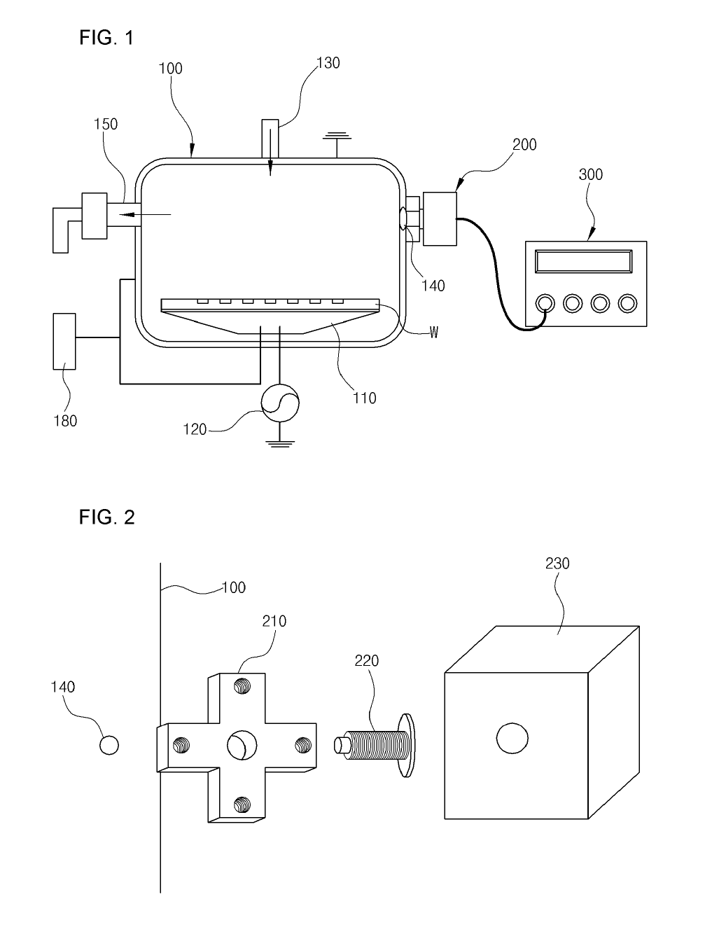

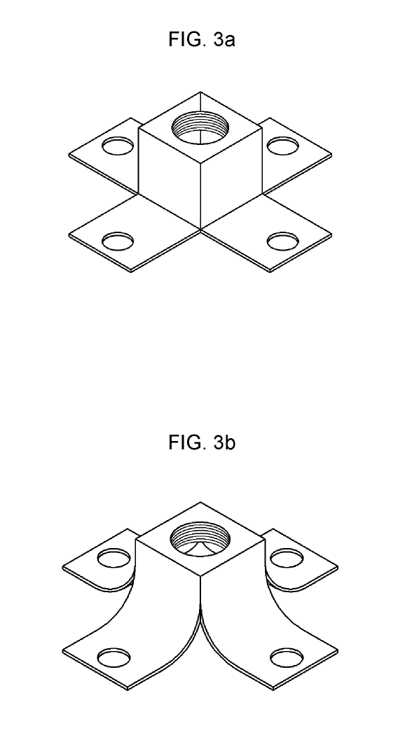

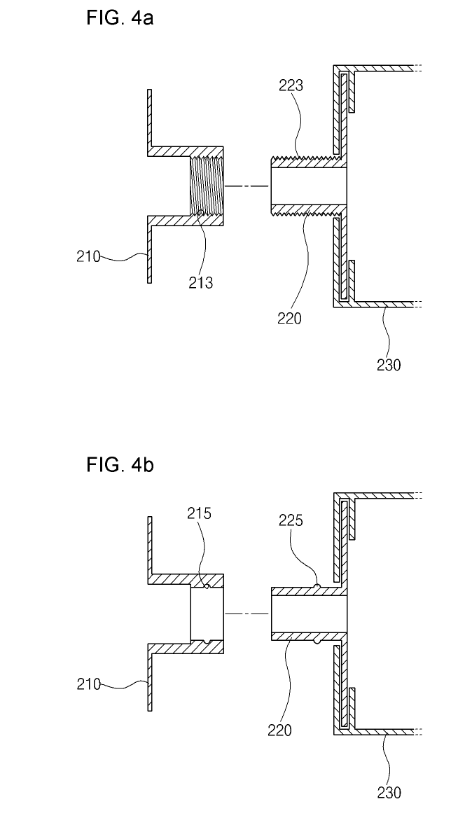

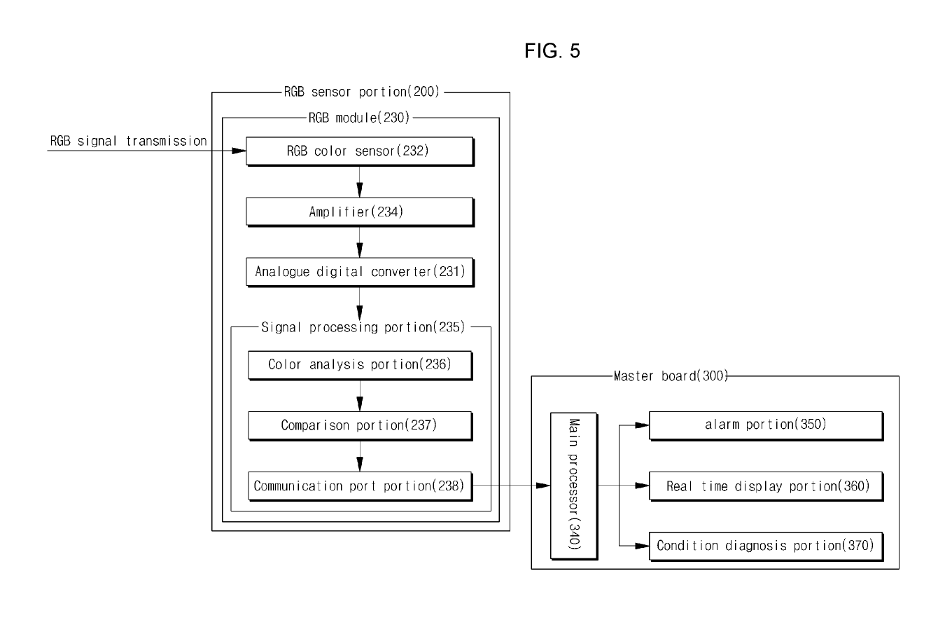

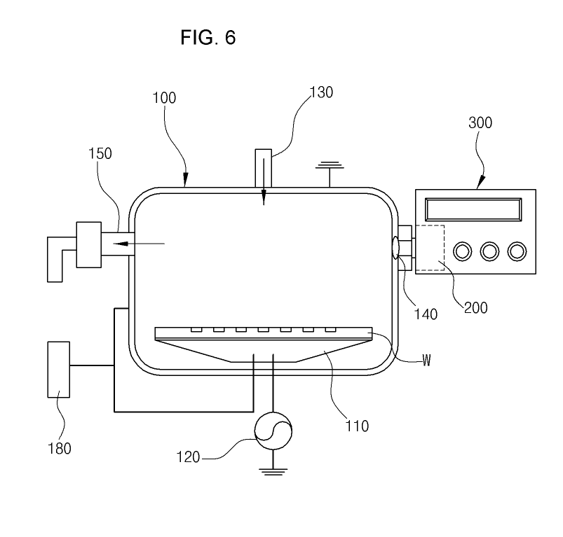

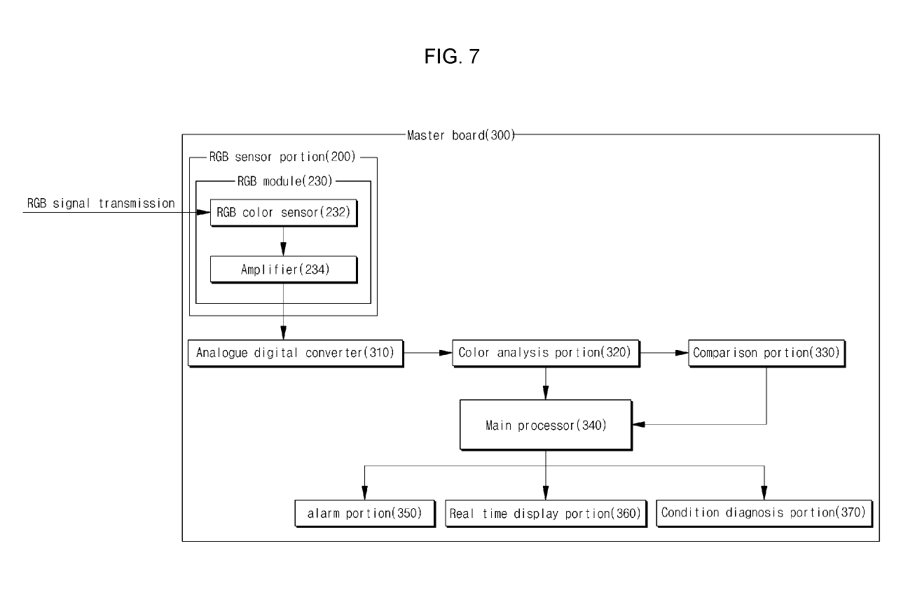

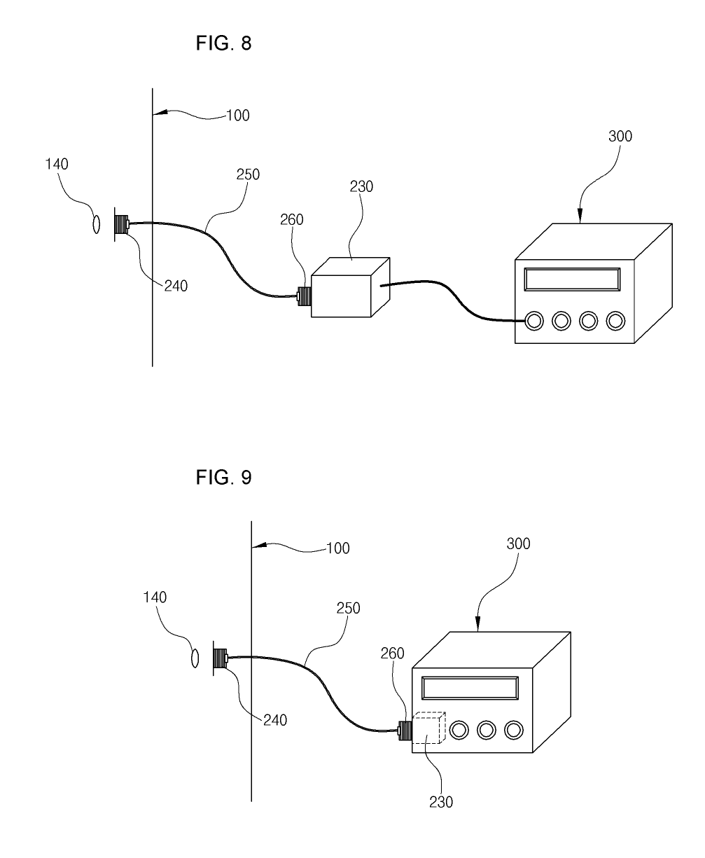

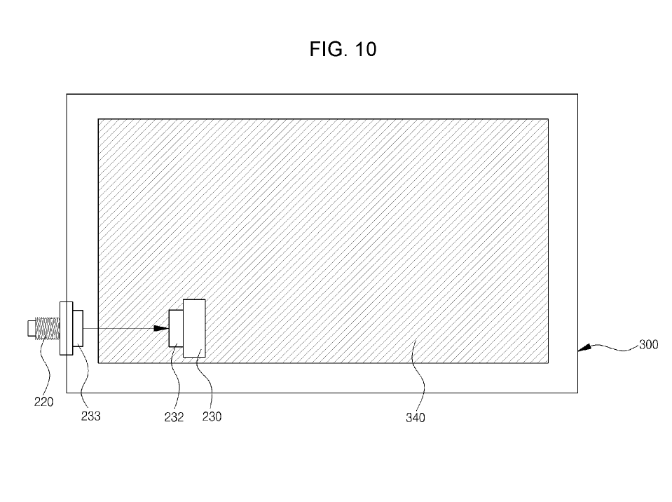

FIG. 1 is a schematic view of plasma process system in which arc detecting apparatus according to present invention is applied, FIG. 2 is a schematic view of RGB sensor portion, FIG. 3a, 3b show various shapes of adaptors included in the RGB sensor portion, FIG. 4a, 4b are cross sectional views of connecting structure of adaptor and connector and RGB module, FIG. 5 is a block diagram of RGB sensor portion and master board, FIG. 6 is another schematic view of plasma process system in which arc detecting apparatus according to present invention is applied, FIG. 7 is a block diagram of RGB sensor portion and master board of FIG. 7, FIG. 8 is a schematic view of plasma process apparatus in which devices are connected by optical cable, FIG. 9 is a schematic view of another embodiment of FIG. 8, FIG. 10 is a schematic side cross sectional view of master board including RGB sensor portion.

As seen in FIG. 1 to FIG. 10, the apparatus for detecting arc according to present invention comprises, a RGB sensor portion 200 including RGB module 230 sensing respective red, green, and blue color of light emitted from plasma in plasma process chamber 100; a master board 300 processing signals from the RGB sensor portion 200 and controlling the process chamber 100 or displaying process condition of the chamber; a analogue digital converter 231, 310 for converting RGB signal sensed by the RGB sensor portion 200 to digital signal; a color analysis portion 236, 320 converting digital RGB signal to numerically quantitative RGB light data of plasma by analysis for respective RGB signal; a comparison portion 237, 330 comparing the RGB light data transmitted from the color analysis portion 236, 320 with RGB light data obtained from plasma in normal condition; and the RGB module 230 includes, a RGB color sensor 232 receiving light of red, green, and blue from plasma gas in process chamber 100 through R channel sensor, G channel sensor, and B channel sensor; a amplifier 234 amplifying signal sensed by the RGB color sensor 232; and the master board 300 includes, a main processor 340 outputting control signal for controlling operation of process chamber 100 or display signal for displaying condition of process chamber 100 by gathering the RGB light data transmitted from the color analysis portion 236, 320 and signal transmitted from the comparison portion 237, 330; an alarm portion 350 outputting alarm melody or alarm light according to signal transmitted from the main processor 340; a real time display portion 360 for displaying data related with process parameter in the process chamber 100 according to the signal transmitted from the main processor such that operator may confirm condition of the process chamber 100.

Here, in the process chamber 100, stage 110 on which semiconductor wafer W is positioned is provided, and after semiconductor wafer W is positioned on the stage 110, reaction gas is injected through gas injection portion 130.

After then, by applying electric power into the process chamber with RF power 120, reaction gas injected into the process chamber is changed to plasma condition, dry etching or dry deposition process for semiconductor wafer W that has finished photograph and deposition process is performed.

Here, for the plasma, low temperature-vacuum plasma can be used in which pressure of reaction gas is maintained under several˜several hundred mTorr, but not limited to this.

Meanwhile, during the etching or deposition process, light emitted from plasma can be collected by view port provided in side wall of the process chamber 100, and the collected light is transmitted to the RGB sensor portion 200 for checking condition of plasma in process.

Here, the view port 140 is provided by sealing opening in side wall of the process chamber 100 with two transparent glass windows that has high penetrability of light and heat-pressure resistance. And, between the glass windows and the process chamber 100 is sealed by heat-resistant silicone or the like to prevent leakage of gas in the process chamber, however not limited to this configuration.

Preferably, lens can be included to condense light and amplify intensity of light.

And, during the etching process, temperature of wafer chuck included in the stage 110 is maintained to be proper for the process through temperature controller 160 in the process chamber 100.

Here, the wafer chuck is for positioning and securing the wafer on the stage 110, so the wafer chuck contacts with the wafer in plasma process, and temperature of the chuck and wafer have close relationship.

Temperature of the wafer and the wafer chuck affects on etching rate of wafer and quality of process in plasma process, temperature of the wafer chuck needs to be properly controlled by the temperature controller 160.

When etching process is finished, temperature in the chamber falls down by the temperature controller 160, and reaction gas in the chamber is discharged outside by vacuum pump of the discharging device 150 for preparing next etching process.

Meanwhile, as shown in FIG. 2, the RGB sensor portion 200 is configured to include adaptor 210, connector 220, and RGB module 230.

Here, as shown in FIG. 2, the adaptor 210 of the RGB sensor portion 200 is provided as “+” shape basically, however for easy connection with process chamber 100 of various shape, “◯” or “−” shape may be available.

And, by providing the adaptor 210 as “+” shape, the adaptor can last shock from up and down or right and left, and can support sufficiently the RGB module 230 that is connected with the adaptor 210.

FIGS. 3a and 3b are schematic views of preferable embodiments of the adaptor 210, as shown in FIG. 3b, slow slope may be formed toward center portion of the adaptor 210, or the center portion may protrude vertically, and that may be applied in adaptor 210 of “◯” or “−” shape type.

That is, as shown in FIG. 3a, 3b, end portion of the adaptor 210 is formed to be vertically protruded or slowly sloped, even though out surface of the process chamber 100 is formed to have spheric shape or the RGB module 230 is installed at corner portion of the process chamber 100, the adaptor 210 can be easily installed disregards of shape of the process chamber 100 or installation position of the RGB module 230.

And, as shown in FIG. 4a, 4b, in central portion of the adaptor 210, screw hole 213 for bolt-nut connection or insert hole 215 for insert connection with the connector 220 may be provided, and plural openings for bolt connection with the process chamber 100 are provided in edge portion of the adaptor 210.

Meanwhile, the connector 220 has a cylindrical shape in which opening portion is formed at central portion, and at end portion toward the RGB module 230, plate is formed to make firm connection and prevent light leakage, and area of the plate may be larger than cross sectional area of the cylindrical shape.

And, screw projection or insert projection may be provided on outer surface of the connector 220, thereby the connector can be easily attached or detached.

Meanwhile, the RGB module 230 is essential element of the present invention, and it senses light from plasma in the process chamber 100.

Here, the RGB module 230 includes RGB color sensor 232 in which R channel sensor receiving light of red color, G channel sensor receiving light of green color, and B channel sensor receiving light of blue color are provided in plural and a amplifier 234 amplifying signal sensed by the RGB color sensor 232.

Here, the amplifier 234 amplifies the light received by the respective channel for exact conversion of the light to electric light data.

At this time, sensitivity of the respective RGB channel may be different from one another, so amplifying multiple for respective channel may be different for compensation.

Meanwhile, the RGB sensor portion 200 may be installed in side wall of the process chamber 100 independently, or in the master board 300 integrally.

When the RGB sensor portion 200 is installed in side wall of the process chamber 100 independently, the RGB module 230 included in the RGB sensor portion 200 includes the RGB color sensor 232, the amplifier 234, and other elements described hereinafter.

That is, as seen in FIG. 5, the RGB module 230 further includes an analogue digital converter 231 for converting RGB signal amplified by the amplifier 234 to digital signal, a signal processing portion (DSP, MCU processor) 235 for processing signal converted by the analogue digital converter 231, and the signal processing portion 235 includes a color analysis portion 236 converting condition of plasma to numerically quantitative RGB light data by respective analysis of the RGB signal that is converted to digital data by the digital converter 231, a comparison portion 237 comparing RGB light data transmitted from the color analysis portion 236 with RGB light data obtained from plasma in normal condition, and a communication port portion 238 communicating with the master board 300.

Here, the master board 300 includes a main processor 340 outputting control signal for controlling operation of process chamber 100 or transmitting display signal for displaying condition of process chamber 100 by gathering the RGB light data transmitted from the color analysis portion 236 and signal transmitted from the comparison portion 237, an alarm portion 350 outputting alarm melody or alarm light according to signal transmitted from the main processor 340, a real time display portion 360 for displaying data related with process parameter in the process chamber 100 according to the signal transmitted from the main processor 340 such that operator may confirm condition of the process chamber 100.

Meanwhile, when the RGB sensor portion 200 is installed in the master board 300, as seen in FIGS. 6 and 7, the RGB sensor portion 200 is installed in the master board 300 integrally.

Here, the master board 300 may include an analogue digital converter 310 for converting RGB signal from the RGB sensor portion 200 to digital signal, a color analysis portion 320 for numeric quantitating condition of plasma in the process chamber by analyzing respectively the RGB signal that is converted to digital signal, a comparison portion 330 comparing signal transmitted from the color analysis portion 320 with RGB signal obtained from plasma of normal condition, a main processor 340 outputting control signal for controlling operation of process chamber 100 or display signal for displaying condition of process chamber 100 by gathering the RGB light data transmitted from the color analysis portion 320 and signal transmitted from the comparison portion 330, an alarm portion 350 outputting alarm melody or alarm light according to signal transmitted from the main processor 340, a real time display portion 360 for displaying data related with process parameter in the process chamber 100 according to the signal transmitted from the main processor 340 such that operator may confirm condition of the process chamber 100, and a condition diagnosis portion 370 displaying whether operation condition of the process chamber is normal or not based on signal transmitted from the comparison portion 330 and the main processor 340.

That is, the RGB sensor portion 200 may be provided to be installed outside of the process chamber and connected to the master board 300, or to be installed in the master board 300 integrally.

Meanwhile, structure of the RGB color sensor 232 may be as follows in which same channel sensors are grouped by respective color to be classified in three R, G, B groups.

$$… \\ [ R ] [ R ] [ R ] [ G ] [ G ] [ G ] [ B ] [ B ] [ B ] \\ [ R ] [ R ] [ R ] [ G ] [ G ] [ G ] [ B ] [ B ] [ B ] \\ [ R ] [ R ] [ R ] [ G ] [ G ] [ G ] [ B ] [ B ] [ B ]$$

$$…$$

([R]: R channel sensor, [G]: G channel sensor, [B]: B channel sensor)

Or structure of the RGB color sensor 232 may be grid type as follows.

$$… \\ [ R ] [ G ] [ B ] [ R ] [ G ] [ B ] [ R ] [ G ] [ B ] \\ [ B ] [ R ] [ G ] [ B ] [ R ] [ G ] [ B ] [ R ] [ B ] \\ [ G ] [ B ] [ R ] [ G ] [ B ] [ R ] [ G ] [ B ] [ R ]$$

$$…$$

Or structure of the RGB color sensor 232 may be stripe type as follows.

$$… \\ [ R ] [ G ] [ B ] [ R ] [ G ] [ B ] [ R ] [ G ] [ B ] \\ [ R ] [ G ] [ B ] [ R ] [ G ] [ B ] [ R ] [ G ] [ B ] \\ [ R ] [ G ] [ B ] [ R ] [ G ] [ B ] [ R ] [ G ] [ B ]$$

$$…$$

And, respective said structure may be repetitive.

Here, sensitivity of respective RGB channel may be different from one another, distribution rates of sensors in respective RGB channel that are installed in the whole RGB color sensor 232 may be different from one another, but not limited to this.

And, as RGB signal output from the RGB module 230 is analogue electric signal, so there is no limit in signal band of the RGB signal, thereby different electric signal can be generated according to very small change of plasma light.

Meanwhile, opening for connection with the connector 220 is provided in the RGB module 230, and light of the plasma that passes the view port 140 of the process chamber and the connector 220 through the opening can reach the RGB color sensor 232.

Here, the opening of the RGB module 230 has a area sufficient for passage of the screw projection or insert projection formed on surface of the cylindrical shape of the connector 220.

Connection order of the RGB module 230 to the process chamber 100 is,

1. Installing adaptor 210 suitable for the shape of the process chamber 100 to a position where view port 140 is positioned.

2. Connecting the connector 220 with the RGB module 230.

3. Connecting the adaptor 210 with the connector 220.

In the step 2, the RGB module 230 and the connector 220 may be provided integrally, otherwise at opening part of the RGB module 230, open structure for easy connection of plate portion of the connector 220 may be provided, but not limited to this.

Here, the open structure may be provided in side wall of the RGB module 230 adjacent to the opening, and the RGB module 230 and the connector 220 can be connected in a way that cylindrical portion of the connector 220 is exposed to outside through the opening of the RGB module 230 and after that by closing the open structure.

That is, by the opening of the RGB module 230 and plate portion of the connector that is positioned in the RGB module 230, the RGB module 230 and the connector 220 are firmly connected.

And, the adaptor 210 and the connector 220 can be firmly connected by screw hole 213 or insert hole 215 formed in the adaptor and screw protrusion 223 or insert protrusion 225 formed in the connector 220, when connection of the two elements are finished, end portion of the connector 220 contact on outer window of the view port 140 in the process chamber 100.

To prevent light leakage from gap between outer window of the view port 140 and the end portion of the connector 220, elastic rubber or resin of ring shape can be attached at end portion of the connector 220.

Through the connection like above, light leakage can be prevented by contact between view port 140 of the process chamber 100 and the connector 220, so light can be transmitted to the RGB module 230 without leakage, and the adaptor 210 and the connector 220 can be easily attached and detached by the connection type of insert connection or bolt-nut connection.

And, by configuration of the RGB sensor portion 200 like above, signal transmission between the RGB sensor portion 200 attached to the process chamber 100 and the master board 300 that is spaced away from the process chamber can be done through general cable like power line, so there is no limit on bending or length of the line.

FIG. 8 is a schematic view of another embodiment of the RGB sensor portion, another connection type between the view port 140 and the RGB module 230 is shown.

That is, the RGB sensor portion includes optical cable adaptor 240 preventing light leakage and connecting the view port 140 and optical cable 250, optical cable 250 transmitting light of plasma from the optical cable adaptor 240 to the RGB module 230, and a optical cable connector 260 positioned between the optical cable 250 and the RGB module 230 to connect the optical cable 250 to the RGB module 230, and transmitting light of plasma transmitted through the optical cable 250 to the RGB module 230.

Here, the optical cable adaptor 240 transmits light of plasma emitted to outside through view port 140 of the process chamber 100 to the optical cable 250 with effective condensation, and fixes end portion of the optical cable to face the outer window of the view port 140 exactly.

And, the optical cable adaptor 240 protects end portion of the optical cable that may be easily damaged.

And, the optical cable connector 260 firmly connects the optical cable 250 and the RGB module 230, and seals the connection part to prevent light leakage.

Preferably, in the optical cable connector 260, lens for amplifying light transmitted through the optical cable 250 can be included.

By providing the RGB sensor portion 200 as above, only the optical cable adaptor 240 and the optical cable occupying small space can be installed in the process chamber 100, and other elements including the RGB module 230 or the like can be installed in other position, thereby efficient use of space can be possible.

And, in the embodiment, two structures of the RGB sensor portion 200 (independent structure and integral structure with master board) may be as shown in FIGS. 8 and 9, however except connection structure by optical cable 250, other elements are same with above said embodiments, so repeated explanations are omitted.

Meanwhile, the master board 300 rates the RGB signal transmitted from the RGB sensor portion 200 to digital data, and compare it with standard data to judge whether condition of plasma in process chamber is in normal condition or not, and displays it outside.

Here, the master board 300 includes an analogue digital converter 310 for converting RGB signal output from the RGB sensor portion 200 to digital signal, a color analysis portion 320 quantifying condition of plasma in process chamber by respective analysis of the RGB signal that is converted to digital data, a comparison portion 330 comparing signal transmitted from the color analysis portion 320 with RGB signal value obtained from plasma in normal condition, a main processor 340 outputting control signal for controlling operation of process chamber 100 or display signal for displaying condition of process chamber 100 by gathering the signal transmitted from the color analysis portion 320 and signal transmitted from the comparison portion 330, an alarm portion 350 outputting alarm melody or alarm light according to signal transmitted from the main processor 340, a real time display portion 360 for displaying data related with process parameter in the process chamber 100 according to the signal transmitted from the main processor 340 such that operator may confirm condition of the process chamber 100, and a condition diagnosis portion 370 displaying whether operation condition of the process chamber is normal or not based on signal transmitted from the comparison portion 330 and the main processor 340.

Plural analogue digital converters 310 may be provided for rapid conversion of analogue RGB signal in real time.

That is, the analogue digital converter 310 can be provided for respective RGB channel, or plural analogue digital converters 310 can be provided to process total RGB signals in parallel.

And, when the RGB signals output from RGB sensor portion 200 are converted to digital signals through the analogue digital converter 310, not only general 8 bit RGB signal system that has color express step of 0˜255, but also 10 bit (0˜1023), 12 bit (0˜4095), 14 bit (0˜8195), 16 bit (0˜65535), 20 bit (0˜1048575), 24 bit (0˜16777215), etc. can be available for expression of very small change in signal, but not limited to this.

The color analysis portion 320 forms RGB light data that is available in comparison portion 330 by mapping digital RGB signals transmitted from the analogue digital converter 310 into three dimensional coordinate of R channel data, G channel data, and B channel data.

That is, the color analysis portion separates digital RGB signal transmitted from the analogue digital converter 310 by respective channel and recombines as R channel data, G channel data, and B channel data.

Or, the color analysis portion can convert digital data of respective RGB channel to hue (H), saturation (S), and brightness (B) to express in three dimensional coordinate.

Here, the hue has a value of 0˜360, the saturation and brightness have the maximum value according to the number of bit determined by the analogue digital converter 310.

First of all, the saturation may be one as follows.

S=[((maximum value of RGB)−(minimum value of RGB))/(maximum value of RGB)]×2^{bit}

And, the brightness may be one as follows.

B=(maximum value of RGB)

And, the hue may be one as follows.

When value R is maximum in R, G, B,

H=[(data of G channel−data of B channel)/(maximum value of RGB−minimum value of RGB)]×60

When value G is maximum in R, G, B,

H=[2.0+{(data of B channel−data of R channel)/(maximum value of RGB−minimum value of RGB)}]×60

When value B is maximum in R, G, B,

H=[4.0+{(data of R channel−data of G channel)/(maximum value of RGB−minimum value of RGB)}]×60

If the H is smaller than 0, 360 may be added to produce hue data, but not limited to above formula.

Preferably, process time data may be included in the three dimensional data, and by the process time data, plasma condition can be traced along the process, so accuracy of plasma process can be improved.

The comparison portion 330 is for comparing RGB light data ((R, G, B) or (H, S, B) coordinate data) transmitted from the color analysis portion 320 in real time with RGB light data obtained from plasma in normal condition.

Meanwhile, FIG. 10 is a schematic cross sectional view of master board 300 in which RGB sensor portion 200 is integrally installed and that shows positions of connector and RGB module.

Here, the connector 220 is installed at lower part of the master board 300, and the RGB module 230 is installed oppositely to the connector 220 in the master board 300.

Or, when process chamber and master board 300 are connected through optical cable 250, the optical cable connector 260 is installed at lower part of the master board 300, and the RGB module 230 may be installed oppositely to the optical cable connector 260 in the master board 300.

By that, the connector 220 transmitting RGB signal and aim lens connected with the connector are installed oppositely to the RGB color sensor 232 included in the RGB module 230, and by adjusting focus distance of the aim lens 233, stable sensing structure can be made.

Conventionally, plural polarizing glass for transmitting light uniformly to optical sensor and plural adjusting screws for adjusting reflecting angle of the polarizing glass has been used for transmitting light.

However, in the present invention, RGB signal transmitted to the connector 220 is transmitted directly to the RGB color sensor 232 through the aim lens 233, so stable and reliable sensing structure can be provided.

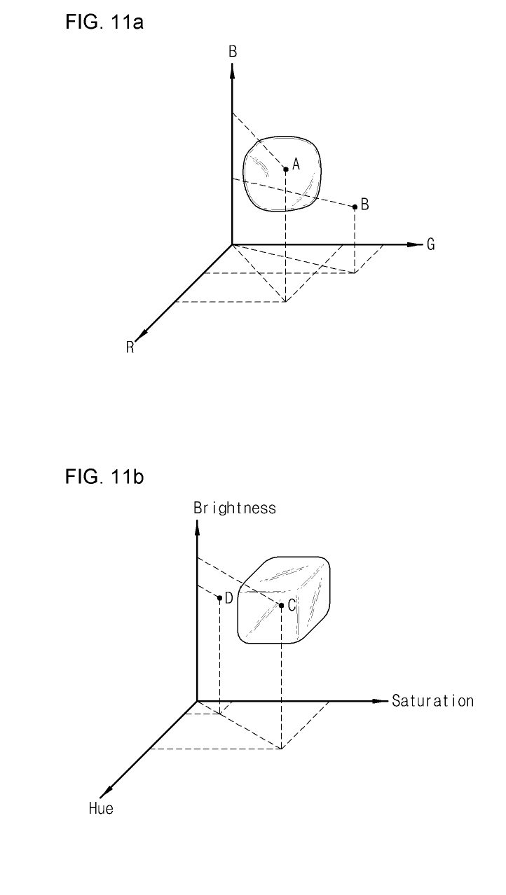

FIGS. 11a, 11b are graphs in which RGB light data space of process permission range is represented in three-axis coordinate, when value of RGB light data sensed by real time is in the RGB light data space of process permission range(A), present condition of the plasma is determined to be in normal condition, and value of RGB light data sensed by real time is not in the RGB light data space of process permission range(B), present condition of the plasma is determined to be in abnormal condition.

And, that is equally applied to a case in which RGB light data is represented by HSB coordinate data, so when in process permission range(C) and not in process permission range(D) are distinguished.

And, in this case, values of coordinate are different in RGB coordinate and HSB coordinate for same condition, shapes of process permission range are different according to axis of coordinate.

Meanwhile, the comparison portion 330 compares R channel data, G channel data, and B channel data of RGB light data (or, H data, S data, B data) with respective R, G, B data (or, H, S, B data) of process permission range, when at least one data of the three light data gets out of normal range, the comparison portion outputs signal that represents present condition of plasma as being abnormal.

For example, if R channel data of process permission range is 20˜37, G channel data of process permission range is 33˜50, and B channel data of process permission range is 79˜81, and value of RGB light data sensed in real time is 21, 42, 80, condition of present plasma is determined to be normal.

However, if value of RGB light data sensed in real time is 19, 35, 81 in which R channel data is out of process permission range, condition of present plasma is determined to be abnormal.

Here, as the RGB light data of process permission range that is standard of judgment, RGB light data obtained from previous normal process data or from previous demonstration process is used.

And, as condition of plasma is changed by progression of process, RGB light data of process permission range of respective process step is also changed, and that may be represented as three-dimensional shape as in FIGS. 11a, 11b that are changed in size and position according to time flow.

The main processor 340 is a main portion of the master board 300 that collects various condition data from the color analysis portion 320, comparison portion 330, and the process chamber 100, and outputs control signals according to condition.

That is, the main processor 340 receives process input parameter of process chamber, really sensed process variables (pressure of gas, flux quantity of gas, applied electric power), RGB light data transmitted from the color analysis portion 320, judgment signal transmitted from the comparison portion 330 that determines whether condition of plasma is in normal or not, and transmits process input parameter, real process variables, and RGB light data to real time display portion 360 that is described hereinafter.

Here, when condition of plasma is in normal condition, the main processor 340 further transmits signal that represents condition of plasma as being in normal condition to condition diagnosis portion 370 described hereinafter.

However, when condition of plasma is in abnormal condition, the main processor 340 transmits alarm output signal to alarm portion 350 described hereinafter, and further transmits signal that represents condition of plasma as being in abnormal condition to the condition diagnosis portion 370.

Preferably, the main processor may output control signal for changing condition of plasma to normal condition and transmit the signal to the process chamber 100, thereby defect rate of plasma process can be reduced.

Here, in the control signal, signals for changing quantity and pressure of reaction gas, process time, magnitude of electric power, and operation of temperature controller of process chamber 100 may be included.

Alarm portion 350 is for outputting alarm siren or alarm light according to alarm output signal of the main processor 340 when condition of plasma is in abnormal condition.

Here, the alarm portion 350 is installed outside of process chamber 100 or at control device that controls total process, etc., and directly informs abnormality of plasma process to operator.

Real time display portion 360 displays all information about process chamber 100 in present time, preferably LCD touch panel, or general LCD monitor may be provided, but not limited to these.

Here, information that is displayed through the real time display portion 360 includes progress time of process, progress degree of process, process input parameter of process chamber 100, real process variables, RGB light data obtained from plasma by real time, and RGB light data of process permission range, but not limited to these.

The condition diagnosis portion 370 is a device for indicating whether present plasma in process chamber 100 is in the process permission range or not, and the condition diagnosis portion may be included in the real time display portion 360.

The condition diagnosis portion 370 indicates abnormality of plasma, and may further indicate data about following-up RGB light data according to progress of process time.

The RGB sensor portion 200 senses change quantity of light emitted from reaction gas input into process chamber 100 of plasma process for semiconductor and light emitted when gas is changed from normal condition-excited condition-ground condition.

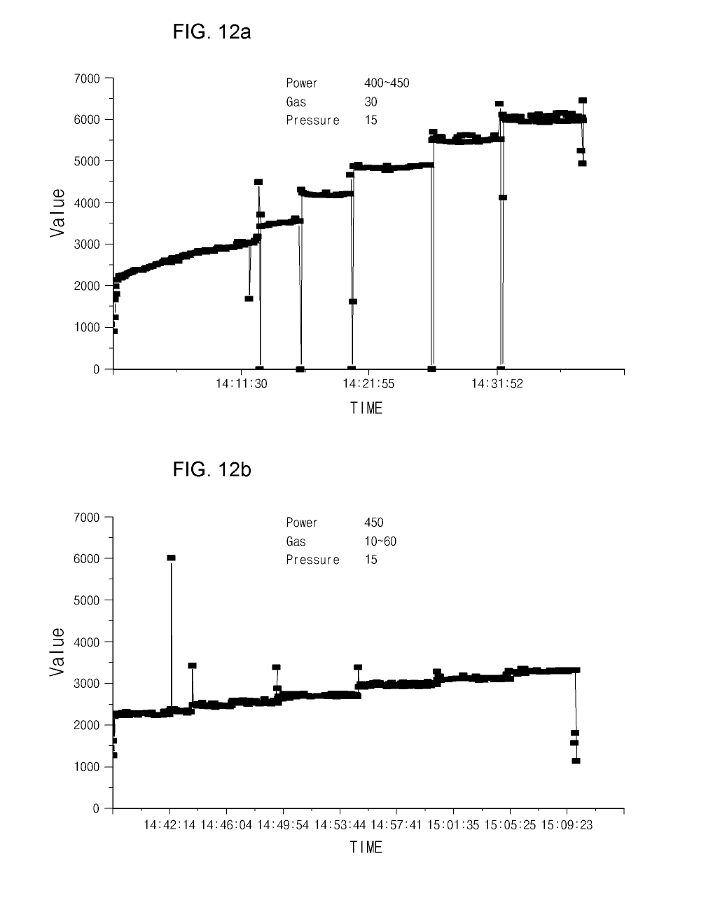

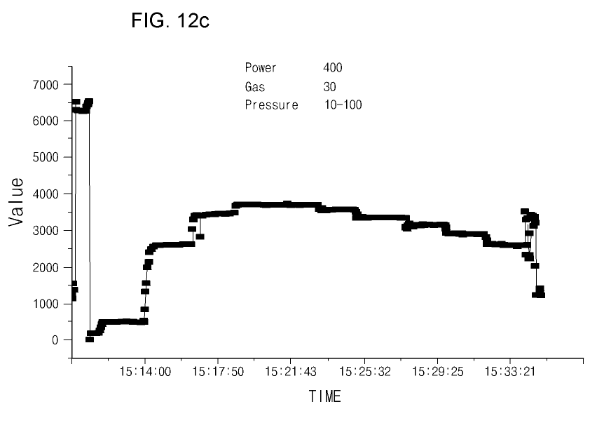

FIGS. 12a, 12b, 12c are graphs showing value change of RGB light data according to process input parameter, FIG. 12a shows brightness of plasma according to change of electric power applied to plasma, 12b is for according to change of flux quantity of gas, and 12c is for according to change of gas pressure, quantitative data may be provided from the brightness of plasma.

That is, as seen in FIGS. 12a, 12b, 12c, different RGB light data are obtained according to change of respective process input parameter, process permission range data and real time RGB light data may be obtained that has small difference according to progress of plasma process.

Specifically, brightness of plasma proportionally increases according to increase of applied electric power and flux quantity of gas, minute change of plasma condition may be quantitatively obtained by the relationship.

And, in FIG. 12c that is for gas pressure, quantitative data according to plasma condition can be obtained by measuring graph slope in vicinity of gas pressure of 50 mTorr for example.

The quantitative data obtaining may be possible through not only measuring brightness of plasma, but also measuring change in hue or saturation of red, green, and blue light sensed by RGB sensor portion 200.

As mentioned above, by the apparatus for detecting arc according to present invention, inside of process chamber can be monitored promptly, and abnormal condition of plasma in process chamber can be detected by real time, and flexibility of apparatus structure can be provided by installing RGB sensor portion independently or installing the RGB sensor portion in master board.

And, defect rate by abnormal condition of plasma can be reduced in wafer etching process and minute process control is possible, and by using adaptor of various shape, plasma monitoring device can be firmly installed, and by using connector to prevent light leakage, correct plasma monitoring is possible.

Plasma monitoring device can be installed freely disregards of structure, shape, and special restriction of chamber.

Although the present invention has been described with reference to the specified examples in the above, but the idea of the present invention is not limited to the above described matters and various changes and modifications can be made within the equivalent scope of the present invention and the following claims by the ordinary-skilled person of the art.

What is claimed is:

1. An apparatus for detecting arc comprising:
a RGB sensor portion including RGB module sensing respective red, green, and blue color of light emitted from plasma in plasma process chamber;
a master board processing signals from the RGB sensor portion and controlling the process chamber or displaying process condition of the chamber;
a analogue digital converter for converting RGB signal sensed by the RGB sensor portion to digital signal;
a color analysis portion converting digital RGB signal to numerically quantitative RGB light data of plasma by analysis for respective RGB signal;
a comparison portion comparing the RGB light data transmitted from the color analysis portion and RGB light data obtained from plasma in normal condition; and
the RGB module includes,
a RGB color sensor receiving light of red, green, and blue from plasma gas in process chamber through R channel sensor, G channel sensor, and B channel sensor;
a amplifier amplifying signal sensed by the RGB color sensor; and
the master board includes, a main processor outputting control signal for controlling operation of process chamber or display signal for displaying condition of process chamber by gathering the RGB light data transmitted from the color analysis portion and signal transmitted from the comparison portion;
an alarm portion outputting alarm melody or alarm light according to signal transmitted from the main processor;
a real time display portion for displaying data related with process parameter in the process chamber according to the signal transmitted from the main processor such that operator may confirm condition of the process chamber.

2. The apparatus for detecting arc according to claim 1, wherein the RGB module includes, the analogue digital converter; and
a signal processing portion having the color analysis portion, the comparison portion, and communication port portion communicating with the master board, and the RGB sensor portion including the RGB module is installed oppositely to view port of process chamber.

3. The apparatus for detecting arc according to claim 2, wherein the RGB sensor portion and the master board are connected with each other by communication line, so the RGB sensor portion and the master board are installed independently of each other.

4. The apparatus for detecting arc according to claim 1, wherein the RGB sensor portion is provided in the master board integrally, and the master board includes the analogue digital converter, the color analysis portion, and the comparison portion.

5. The apparatus for detecting arc according to claim 4, wherein the master board including the RGB sensor portion is installed oppositely to view port of process chamber

6. The apparatus for detecting arc according to claim 1, wherein the RGB module includes, a analogue digital converter;
a signal processing portion having the color analysis portion, the comparison portion, and communication port portion communicating with the master board, and
the RGB sensor portion including the RGB module is connected with view port of process chamber through optical cable.

7. The apparatus for detecting arc according to claim 6, wherein the RGB sensor portion is connected with the master board through communication line, and the RGB sensor portion and the master board are installed independently of each other.

8. The apparatus for detecting arc according to claim 1, wherein the RGB sensor portion is provided in the master board integrally, and the master board includes the analogue digital converter, the color analysis portion, and the comparison portion, the RGB sensor portion included in the master board is connected with view port of process chamber through optical cable.

9. The apparatus for detecting arc according to claim 1, wherein RGB signal sensed by the RGB sensor portion is converted to numerical value of respective R channel data, G channel data, and B channel data in the color analysis portion, and R, G, B channel data transmitted from the color analysis portion are compared respectively with R, G, B channel data of process permission range in the comparison portion, and when at least one data of the respective channel data is out of the process permission range, plasma in the process chamber is determined to be in abnormal condition.

10. The apparatus for detecting arc according to claim 1, wherein RGB signal sensed by the RGB sensor portion is converted to numerical value of respective R channel data, G channel data, and B channel data in the color analysis portion, and the RGB channel data is converted to hue data, saturation data, and brightness data by combination, and the hue data, saturation data, and brightness data transmitted from the color analysis portion are compared respectively with hue data, saturation data, and brightness data of process permission range in the comparison portion, and when at least one data of the hue data, saturation data, and brightness data is out of the process permission range, plasma in the process chamber is determined to be in abnormal condition.

11. The apparatus for detecting arc according to claim 1, wherein the apparatus further comprises adaptor and connector for connection between the RGB sensor portion and view port of process chamber.

12. The apparatus for detecting arc according to claim 11, wherein the adaptor has “+” shape.

13. The apparatus for detecting arc according to claim 12, wherein the adaptor has gradually protruded shape toward central portion.

14. The apparatus for detecting arc according to claim 13, wherein screw hole is formed in the adaptor, and screw protrusion that has cylindrical shape in which hollow part is formed in central portion is formed in central portion of the connector, the adaptor and the connector is connected by bolt-nut connection type.

15. The apparatus for detecting arc according to claim 13, wherein insert hole is formed in the adaptor, and insert protrusion that has cylindrical shape in which hollow part is formed in central portion is formed in central portion of the connector, the adaptor and the connector is connected by insert connection type.

16. The apparatus for detecting arc according to claim 11, wherein the connector is installed in lower part of the master board, and the RGB module is installed oppositely to the connector in the master board.
